(19) United States
(12) Patent Application Publication
(10) Pub. No.: US 2005/0289580 A1
(43) Pub. Date: Dec. 29, 2005

(54) Optical access apparatus

(75) Inventor: Shan-Yen Yang, Taoyuan City (TW)

Correspondence Address: SNELL & WILMER;ONE ARIZONA CENTER, 400 EAST VAN BUREN, PHOENIX, AZ, 850040001, US

(73) Assignee: BENQ CORPORATION

(21) Appl. No.: 11/148,476

(22) Filed: Jun. 9, 2005

(30) Foreign Application Priority Data
Jun. 15, 2004 (TW) 93117190

(51) Int. Cl. G11B 7/08; G11B 7/085; G11B 7/09

(52) U.S. Cl. 720/689

(57) ABSTRACT

An optical access apparatus is provided. The optical access apparatus includes a mounting plate, characterized in that the mounting plate has a bent portion acting as a balance plate of the optical access apparatus.

### CROSS-REFERENCE TO RELATED APPLICATIONS

This Application claims the right of priority based on Taiwan Patent Application No. 093117190 filed on Jun. 15, 2004.

### FIELD OF INVENTION

The present invention relates to an optical access apparatus. More particularly, the present invention relates to a disc player with a mounting plate.

### BACKGROUND OF THE INVENTION

Disc players are a kind of important data access apparatus among computer-related devices. A disc player has fast access ability as well as large storage capacity. For the reason of convenience, some people even use it as a solution of data backup. Besides, in other aspects, such as entertainment, disc players also play an important role.

When a disc player runs imbalancedly, it vibrates due to spinning. In order to compensate this imbalance, at least one balance plate is therefore attached onto a mounting plate of the disc player.

Referring to FIG. 1, each of the three balance plates 11 is mounted on the mounting plate 10 as an individual element when disc player (not shown) is being assembled, usually by way of screws or rivets. This requires additional steps of the assembly process. In addition, a hole 13 is required on mounting plate 10 for a reading/writing head to operate. Accordingly, in order to form the hole 13, a portion of the material needs to be cut off and discarded.

Therefore, it is preferable that an optical access apparatus has a specially designed mounting plate that requires a simple manufacturing procedure and reduces the waste material, thereby lowering the cost thereof.

### SUMMARY OF THE INVENTION

An object of the present invention is to provide an optical access apparatus. The optical access apparatus has a mounting plate and one or more balance plate(s) thereon is/are fixed without using screws or rivets. This arrangement simplifies the manufacturing procedure of the balance plate(s).

Another object of the present invention is to provide an optical access apparatus with at least one mounting plate. The mounting plate incurs less waste material and it accordingly reduces the total discarded material in manufacturing the optical access apparatus.

Yet another object of the present invention is to provide an optical access apparatus with at least one mounting plate. The optical access apparatus is advantageous in lowering production cost and labor time.

An optical access apparatus is disclosed. The optical access apparatus has a mounting plate, characterized in that the mounting plate has a bent portion acting as a balance plate of the optical access apparatus, and the bent portion and the mounting plate are integrally formed.

Persons skilled in the art will understand the present invention from the following drawings, which are incorporated herein, illustrating embodiments of the invention, together with a general description of the invention.

### BRIEF DESCRIPTION OF THE DRAWINGS

FIG. 1 is a perspective view illustrating a conventional mounting plate.

FIG. 2A is a perspective view illustrating a preferred embodiment of the mounting plate of the present invention at a given stage during the manufacturing process.

FIG. 2B is a perspective view illustrating a preferred embodiment of the mounting plate of the present invention at another given stage during the manufacturing process.

FIG. 2C is a perspective view showing the optical access unit and the guide bar combined together with the mounting plate of the optical access apparatus in accordance with the present invention.

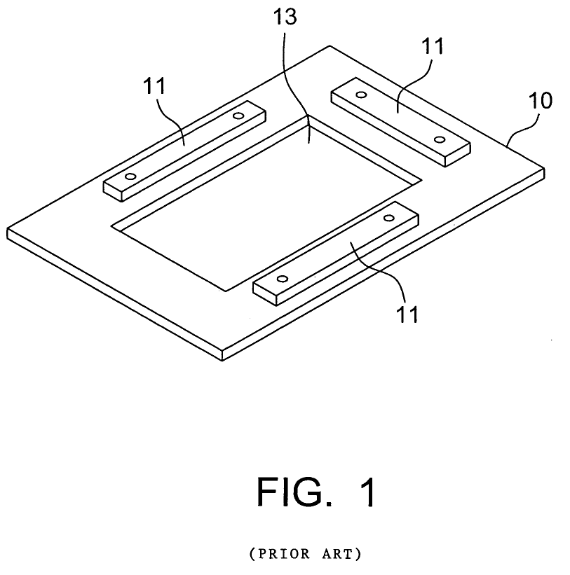

### DETAILED DESCRIPTION

The present invention provides a mounting plate for use in an optical access apparatus. The optical access apparatus is useful in many devices, such as computers, audio-video systems, DVD players, and the like. Moreover, the optical access apparatus are also useful in any other devices that perform data access, preferably with reading/writing functions.

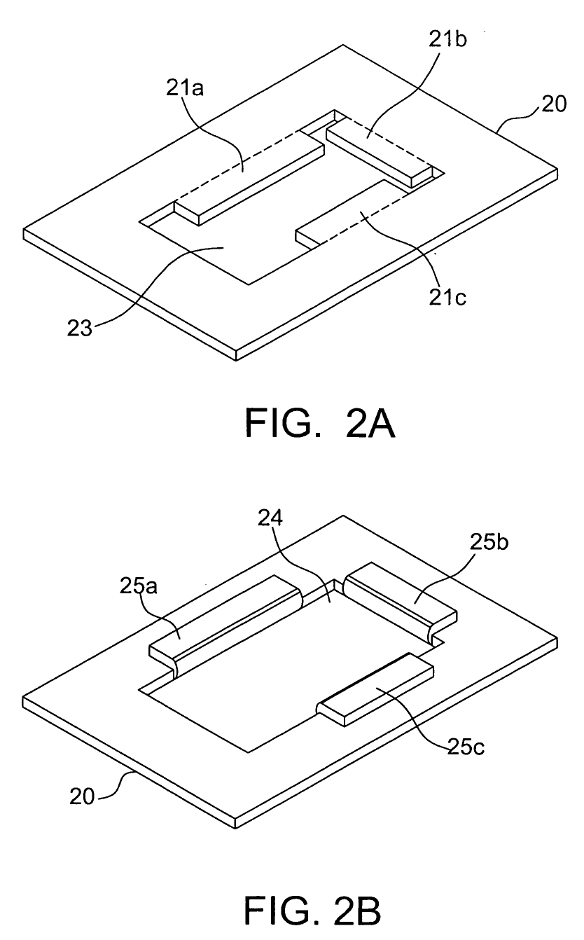

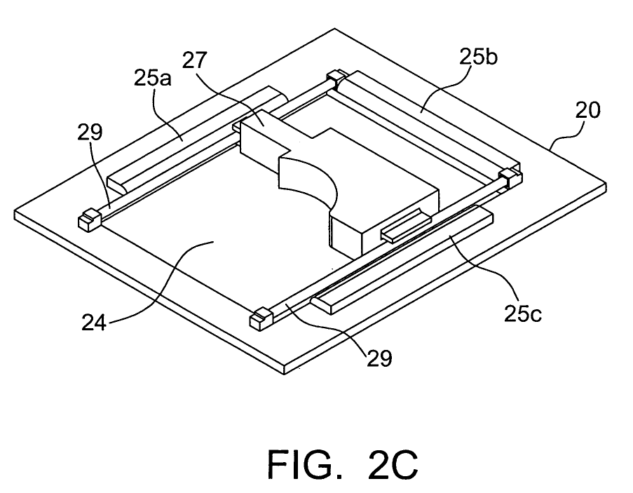

FIG. 2A is a perspective view illustrating a preferred embodiment of the mounting plate 20 of the optical access apparatus in accordance with the present invention at a certain stage during the manufacturing process. The mounting plate 20 includes at least one of parts 21a, 21b, and 21c, and a hole 23. The hole 23 defmes the shape and the location of at least one of the balance plates 25a, 25b, and 25c on the mounting plate 20 in FIG. 2B. The balance plates 25a, 25b, 25c and the mounting plate 20 are integrally formed. The hole 23 can be formed by various methods, such as stamping and shearing, well known to persons skilled in the art.

FIG. 2B is a perspective view illustrating a preferred embodiment of the mounting plate 20 in the optical access apparatus of the present invention at another stage during the manufacturing process. Parts 21a, 21b and 21c are optionally bent to form balance plates 25a, 25b and 25c in order to functionally balance the apparatus. Additionally, the hole 24 is formed by bending balance plates 25a, 25b, and 25c, which are not necessarily to be similarly shaped like those shown in FIG. 2B. Preferably, the balance plates 25a, 25b, and 25c are independently bent, optionally similarly or differently oriented. FIG. 2B is for illustrative purpose only.

In addition, the mounting plate 20 is used for further supporting an optical access unit 27 and a guide bar 29 for gurding the optical access unit. The guide bar 29 may be located as shown in FIG. 2C, in the vicinity to the hole 24, in accordance with the operation of the optical access unit 27 on the mounting plate 20 to keep the optical access unit 27 freely movable in the hole 24. The balance plates 25a, 25b, and 25c in one aspect may be helpful in both balancing the optical access apparatus and the mounting plate 20, and in another aspect do not limit the cooperation of the optical access unit 27 and the guide bar 29.

It should be noted that the size, shape, location of the balance plates are all variable according to different conditions and not limited to what is shown in the drawings. That the balance plates 25a, 25b, 25c and the mounting plate 20, which are integrally formed, not only produce less waste but also simplify the processing process of assembling the balance plates, but also reduce the cost of manufacturing and assembling the optical access apparatus, thereby making the optical access apparatus more cost-effective.

Although a preferred embodiment of the invention has been illustrated and described, it will be obvious to those skilled in the art that various modifications may be made without departing from the scope and spirit of the invention defined by the appended claims.

1. An optical access apparatus comprising a mounting plate, characterized in that said mounting plate has at least one bent portion acting as at least one balance plate of said optical access apparatus, and said bent portion and said mounting plate are integrally formed.

2. The optical access apparatus of claim 1, wherein said bent portion is formed by bending a part of said mounting plate.

3. The optical access apparatus of claim 1, wherein said mounting plate is formed with a hole defining a location of said balance plate.

4. The optical access apparatus of claim 1, wherein said mounting plate comprises two or more said balance plates.

5. The optical access apparatus of claim 4, wherein not all said balance plates are bent in the same direction.

6. The optical access apparatus of claim 4, wherein all said balance plates are bent in the same direction.

7. The optical access apparatus of claim 1, wherein said mounting plate further supports an optical access unit and a guide bar for guiding said optical access unit.

8. An optical access apparatus, comprising:
a mounting plate for supporting an optical access unit and a guide bar for guiding said optical access unit, said mounting plate having at least one bent portion acting as at least one balance plate of said optical access apparatus, and said bent portion and said mounting plate being integrally formed by bending of a part of said mounting plate

9. The optical access apparatus of claim 8, wherein said mounting plate is formed with hole defining a location of said balance plate.

10. The optical access apparatus of claim 8, wherein said mounting plate comprises two or more said balance plates.

11. The optical access apparatus of claim 10, wherein not all said balance plates are bent in the same direction.

12. The optical access apparatus of claim 10, wherein all said balance plates are bent in the same direction.
